(19) United States
(12) Patent Application Publication
(10) Pub. No.: US 2021/0131313 A1
(43) Pub. Date: May 6, 2021

(54) GAS-TURBINE POWER-PLANT WITH PNEUMATIC MOTOR WITH ISOBARIC INTERNAL COMBUSTION

(71) Applicant: Branko Stankovic, Belgrade (RS)

(72) Inventor: Branko Stankovic, Belgrade (RS)

(21) Appl. No.: 16/969,108

(22) PCT Filed: Apr. 10, 2019
(86) PCT No.: PCT/RS2019/050002

§ 371 Date: Aug. 11, 2020

(30) Foreign Application Priority Data
Jun. 8, 2018 (RS) P-2018/0681

(51) Int. Cl. F01K 23/10; F02C 6/18

(52) U.S. Cl. CPC F01K 23/10; F02C 7/143; F02C 6/18

(57) ABSTRACT

The disclosed concept presents a combination of a gas-turbine power-plant and a pneumatic motor, acting as an isobaric motor-combustor for the gas-turbine power-plant, to the end of achievement of a highly efficient generation of energy/power. In the process of isobaric combustion of fuel within the pneumatic motor, the pneumatic motor, which is supplied with compressed air by an air compressor from the gas-turbine power-plant, simultaneously performs mechanical work of isobaric combustion (in addition to the mechanical work of adiabatic expansion of the gas turbine) and thus increases the overall cycle output and the cycle thermal efficiency. Various combinations between gas-turbine power-plant and pneumatic motor are disclosed: simple, simple-recuperated, intercooled and intercooled-recuperated gas-turbine-cycle configurations, as well as simple and intercooled combined gas-turbine-steam-turbine cycle configurations.

### FIELD OF THE INVENTION

The present invention relates to a hybrid gas-turbine-based energy system with a pneumatic motor with isobaric (constant-pressure) internal combustion, which is a combination of a gas-turbine power-plant and a pneumatic motor, acting as an isobaric combustor for the gas-turbine power-plant and in the same time performing mechanical work of isobaric combustion (in addition to the mechanical work of adiabatic expansion of the gas turbine), to the end of achievement of a highly efficient generation of energy/power.

### BACKGROUND OF THE INVENTION

It is a well-known fact to the prior art that one of the simplest and the most straightforward ways of decreasing of CO₂-gas concentration in the atmosphere (which, together with water vapor H₂O, represents the main ingredient of flue gases resulting from combustion of fossil fuels), and thus prolonging the use of non-renewable (fossil & nuclear) fuels, is to increase/improve (cycle thermal) energy efficiency of thermal-to-mechanical (electrical) energy conversion for any kind of fossil fuel used (coal, fuel oil/petroleum and natural gas). It is also very well-known fact that natural-gas fired combined gas/steam turbine power plants (CCGTs) are among those with highest cycle thermal efficiency. The best cycle thermal efficiency of CCGTs is currently about 61% (based on lower heating value (LHV) of fuel, ISO standard conditions), for those gas turbines (GTs) using closed-loop steam cooling (internal convection cooling) of rotors and vanes/blades. In addition, new hybrid concepts have been developed with gas turbines combined with fuel cells, with claimed overall thermal efficiency near 70% (LHV). Prior art also recognizes that GT cycle thermal efficiency could benefit from introduction of a recuperative heat exchanger (recuperator or regenerator), a compressor intercooler(s) or their combination (intercooled-recuperated GT cycle).

On the other hand, it is also well known that the conventional internal combustion engine (ICE), whether of the compression ignition or Diesel type, or of the spark-ignition or Otto type, has a disadvantage of having a low thermal efficiency (30-45%). A principal source of the ICE's inefficiency is its low volumetric efficiency, related to high energy losses contained in large volumes of the ICE's exhaust gases, resulting in wasteful dissipation of the energy (pressure, temperature) contained in them. Plenty of technical solutions have been proposed and/or employed using the ICE's exhaust gases as an energy device, with only modest (or not at all) improvements in the ICE's thermal efficiency.

For example, the ICE's exhaust gases have been used to drive a turbocharger, a form of supercharger, a gas compressor that is used for forced air induction of an ICE, which increases the density of air entering the ICE to create more power, thus improving the ICE's volumetric efficiency. A turbocharger has the compressor powered by a gas-turbine, which is driven by the ICE's exhaust gases rather than direct mechanical drive (as with supercharger). The turbocharger (or supercharger in general) is typically followed by a compressed-air intercooler which contributes to the improvement of the ICE's volumetric efficiency by increasing the intake air density through an isobaric cooling process. By lowering of the intake air temperature, the intercooler also eliminates the danger of pre-detonation (knock) of the fuel-air mixture prior to timed spark ignition in a spark-ignition ICE. However, while turbocharger (with intercooler) has increased the power output of the ICE, no significant increase (or not at all) of the ICE's thermal efficiency has been achieved.

One of important and illustrative prior-art documents in the field of thermal efficiency improvement of a turbocharged ICE is U.S. Pat. No. 4,610,141 (“Compound Engine with Plural Stage Intercooled Exhaust Pump”, 1986) issued to Lin-Shu Wang. The said prior-art document disclosed/proposed a compound positive-displacement internal-combustion engine having a gas turbine driven by the ICE's exhaust gases, a recuperator for transferring the waste heat contained in the fully-expanded exhaust gases to the fresh air incoming into the ICE, and a two-stage intercooled compressor for compressing and evacuating of the cooled-down exhaust gases to the atmosphere, driven by the said gas turbine. Thus, the proposed energy system does not present a turbocharged ICE, but a compound (a hybrid energy system) between a recuperated ICE and an intercooled GT engine. This prior-art document does not explicitly quantify the improvement of the ICE's thermal efficiency but claims that: “the improved internal combustion compound engine is simple, rugged and highly efficient, has a wide range of applicability and is of great versatility and adaptability”.

Another important prior-art document in the field of thermal efficiency improvement of a turbocharged ICE is Technical Paper GT-2007-27198 (“Performance Analysis on Gas Engine—Gas Turbine Combined Cycle Integrated with Regenerative Gas Turbine” by Tadashi Tsuji), presented at the ASME TURBO EXPO 2007 Conference in Montreal, Canada, 2007. The said prior-art document discloses/proposes an “Engine Turbo Compound System”, that is a gas engine (ICE)—GT combined cycle, comprising: a GT engine consisting of a compressor and a GT, with a gas engine (ICE) installed between them, coupled with a bottoming steam-cycle. Thus, essentially the concept represents a turbocharged ICE with supplementary-fired GT, optionally integrated with a bottoming steam-cycle. The source claims high efficiency of the compound energy system resulting from use of the ICE, which represents a “super-high pressure and super-high temperature GT with no cooling air”. Thus, for the ICE's maximum pressure of 160 bar (16 MPa or 2,320 psi) and the maximum temperature of 1,700° C. (1,973 K or 3,092° F.), and for the GT inlet temperature of 1,200° C. (1,473 K or 2,192° F.) and inlet pressure of 14 bar (1.4 MPa or 203 psi), the claimed cycle thermal efficiency is 45% in the GT-ICE simple-cycle mode of operation and 59% in the GT-ICE combined-cycle mode of operation, based on the lower heating value (LHV) of fuel.

The following prior-art document from this field is U.S. Pat. No. 3,826,096 (“Fluid Power Drive System”, issued to Louis C. Hrusch, 1974), which has disclosed an improved fluid power drive system, developing pressurized fluid from a partly-expanded GT-engine (compressor+GT) exhaust gas, supplied for use in operating pneumatic motors or similar fluid responsive devices. In the case that some or all of the pneumatic motors are non-operational for whatever reason, a normally idle GT has been provided, which is able to run on the excess pressurized fluid not required by some or all of the pneumatic motors, released by a variable pressure relief mechanism.

Author of the herein disclosed concept, Branko Stankovic, has also considered thermal efficiency improvement of a hybrid combination of a recuperated GT and a pneumatic motor, similar to the disclosed concept, which he has presented in a very important and relevant prior-art document Technical Paper GT-2011-45259 (“Intercooled-Recuperated Gas-Turbine-Cycle Engine Coupled with Pneumatic Motor with Quasi-Isothermal Heat Addition”), at the ASME TURBO EXPO 2011 Conference in Vancouver, Canada, 2011. The said prior-art document discloses/proposes a hybrid energy system consisting of an intercooled-recuperated GT-cycle engine coupled with a pneumatic motor (compressed-air engine), using reciprocating linear motion of a piston or a rotary vane motor, with quasi-isothermal heat addition process. Both GT engine and pneumatic motor have their own and separate combustion processes, occurring serially one after another, owing to the fact that in the GT engine exhaust gas there is still enough oxygen needed for combustion of fuel (liquid or gaseous) in an internal combustion engine. Three possible configurations of such a hybrid energy system were considered, differing only in the sequence of equipment connecting in the direction of air/working-gas flow (GT-cycle combustor, GT, pneumatic motor with combustor and recuperator). The paper concludes that the most efficient cycle configuration is the one in which quasi-isothermal heat addition/gas expansion in the pneumatic motor occurs right after the GT-cycle heat addition in the associated GT-cycle combustor, with a following cooling of the partly expanded combustion gas in the GT-cycle recuperator, prior to its final expansion in a low-temperature GT and exhaust to atmosphere. Estimated overall cycle thermal efficiency for this preferred system configuration ranges from ˜62% for a maximum GT/pneumatic motor inlet temperature of 1,500 K (1,227° C. or 2,240° F.) to ˜66% for a maximum GT/pneumatic motor inlet temperature of 1,700 K (1,427° C. or 2,600° F.), assuming a purely isothermal heat addition/expansion process in the pneumatic-motor cylinder. The result was attributed to the fact that there is no necessity to cool the low-temperature GT of this configuration. The “quasi-isothermal” nature of the heat addition process within the pneumatic motor was expected to be the result of averaging of the two thermodynamic processes, simultaneously interconnected within a cylinder-piston motor: isobaric heat addition and adiabatic gas expansion. However, in practice this would not be the case, since any heat input within the pneumatic motor would definitely cause a peak in the temperature and thus this would not be an isothermal process.

On the other hand, it is also a well-known fact to the prior art that transport of fluid from a lower to a higher pressure can be accomplished by a pneumatic pumping plant (a positive displacement pump) that uses a compressed compressible fluid (typically air) to move (pump) a non-compressible fluid (typically water) from a lower to a higher pressure. The only energy input required here is electric power needed for driving of the compressor. This pumping concept is already at a mature technological level and it is also easy and convenient to implement.

Although it is unusual to consider converting of a pneumatic pumping plant into a power-producing plant by adding a pneumatic motor to the plant, which would operate between the same pressure levels from a higher to a lower pressure, such concept has however been attempted in the prior art. One of interesting prior-art documents from this field is US Patent Application No. 2005/0193729 A1 (“Trinity Hydro-Pneumatic Power Source”, 2005) filed by Suthep Vichakyothin of Thailand. The said prior-art document discloses/proposes a “trinity” hydro-pneumatic power source comprising a hydraulic turbine, three hydraulic-pneumatic pressure tanks, a higher-pressure pneumatic tank, a vacuum pump, a compressor and a valve controller. The water in the three hydro-pneumatic pressure tanks is compressed and driven by means of high-pressure air coming from the single pneumatic pressure tank, after which it is being expanded in the said hydro-turbine. The vacuum pump then sequentially evacuates air from the three hydro-pneumatic tanks, creating condition for their refilling with water. The evacuated air from sequentially emptied hydro-pneumatic tanks comes to the compressor suction where it is being recompressed back into the higher-pressure pneumatic tank. The cycle is then completed and can restart. This concept bears certain similarity with the concept disclosed herein; however, author of the cited prior-art document does not specifically mention achievements and advantages of the proposed concept in comparison with other modern power-generation concepts.

Another interesting prior-art document from this field is US Patent Application No. 2011/0049909 A1 (“Pneumatic Mechanical Power Source”, 2011) filed by Timothy Domes of the USA. The said prior-art document discloses/proposes a mechanical power system providing torque without using a heat engine, by replacing the fossil-fuel burning engine with a rotary pneumatic motor fed by pressure-regulated compressed gas, preferably compressed nitrogen in a non-liquid state. Supply of compressed gas to the rotary pneumatic motor is achieved by means of an electrically-powered screw-type of compressor. The concept can be applied to automotive, marine and electrical generating applications. When the rotary pneumatic motor is connected to an electrical generator/alternator to generate AC electrical power in large industrial plant applications, the rotary pneumatic motor is driven by DC and converted to AC in an inverter/generator, whereas DC electricity is generated from renewable energy sources, preferably solar panels. While this concept also bears some similarity with the concept disclosed herein, it excludes combination of the pneumatic motor and a heat engine, depending on the supply of renewable energy for the compressor drive. Therefore, author of the cited prior-art document does not provide achievements and advantages of the proposed concept in comparison with modern heat-engines based power-generation concepts.

While the above two US patent applications are rather interesting and, in a way, similar to the herein disclosed concept, it may become apparent to those skilled in the art, as it is to the author of the herein disclosed concept, that the electric power needed for the compressor would definitely exceed the electric power that could be obtained from the pneumatic motor/hydraulic turbine. On the other hand, the herein disclosed/proposed concept highlights a possibility of considerably increasing the net electrical energy output and thus the cycle thermal efficiency using a hybrid combination of a gas-turbine power-plant and a pneumatic motor, acting as an isobaric (constant-pressure) combustor of the gas-turbine engine.

### SUMMARY OF THE INVENTION

The first and the main object of the disclosed invention is to provide a hybrid energy system encompassing a gas-turbine power-plant and a pneumatic motor, acting as a gas-turbine isobaric combustor and in the same time performing mechanical work of isobaric combustion (in addition to mechanical work of adiabatic expansion of the gas turbine), to the end of highly efficient generation of energy/power of such a hybrid energy system. The pneumatic-motor is driven by a gas-turbine compressor, but it is also thermally-driven by isobaric (constant-pressure) heat addition to the compressed-air stream. Such a hybrid engine is herein called a gas-turbine power-plant with a pneumatic motor with isobaric internal combustion.

Looking at the very nature of pneumatic motors as positive-displacement prime movers, it is possible to achieve an increase of the volumetric flow rate of the working fluid (compressed air/gas) without increasing its mass flow rate (and thus without increase of the compressor power and energy consumption) simply by heating of the compressed air to some high temperature. Similarly, in a pneumatic motor-combustor engine it is also important to increase the compressed-gas volumetric flow rate, since this way the useful work of the pneumatic motor can also be increased, due to a more intensive movement of the same mass of the compressed gas tending to occupy a greater volume at the same pressure. The most common way to heat the compressed air to some high temperature is to add (combust) necessary amount of some gaseous/liquid fuel to a combustion chamber with isobaric (constant-pressure) heat addition.

Consequently, one of the most important objects of the invention is to point out that a higher maximum cycle temperature at the combustion chamber exit (closer to modern gas-turbine-inlet temperatures) means more useful work/power output of the pneumatic motor within a hybrid gas-turbine/pneumatic-motor power-plant, due to an increased working-gas volumetric flow rate. A high maximum combustion temperature is therefore very important for the pneumatic motor of such a hybrid energy system, since it will increase the work of isobaric combustion/expansion of the pneumatic motor, while in the same time heating the compressed air supplied by the gas-turbine compressor up to a desired maximum combustion temperature. After simultaneous isobaric heating and isobaric expansion of the compressed air supplied by the gas-turbine compressor to the cylinder of the pneumatic motor of such a hybrid energy system, the heated gas is then supplied to the gas turbine at a slightly lower than the maximum compressed-air pressure, for final adiabatic expansion of the working gas to atmospheric pressure. Since the compressed working gas performs a sort of isobaric (constant-pressure) work at increasing volumes within the pneumatic-motor cylinder of the hybrid energy system, it therefore flows in an isobaric manner through the pneumatic motor, from a smaller volume to a greater volume in the pneumatic-motor cylinder, thus transferring and transforming the compressed-gas power to some kind of motion (typically reciprocating linear). The working-gas pressure, however, remains almost unchanged, that is, at a pressure close to or slightly lower than the maximum compressed-air pressure, since the pneumatic motor continues to receive compressed air supplied by the compressor during an entire volume increase from the top to the bottom dead center along a pneumatic-motor cylinder.

In addition, still another object of the invention is to disclose that it is both possible and desirable to inject a gaseous or liquid fuel into an operating cylinder of the pneumatic motor (wherein atomized fuel is ignited by an electrical spark, like in a spark-ignition engine) of the herein proposed hybrid energy system in one of the following three (3) possible ways/locations: (1) at the top dead center of the operating cylinder, like in a classic spark-ignition internal-combustion engine; (2) at the upper side of the operating piston using a flexible fuel pipe inserted thru the piston, so that the fuel ignites during the piston movement towards the bottom dead center and stops igniting when the bottom dead center has been reached; and (3) combined injection and ignition of fuel by simultaneous use of the said methods (1) and (2).

Still another object of the invention is to emphasize that the pneumatic motor transforms compressed-gas power into some kind of motion, typically reciprocating linear (axial or radial) motion of a piston in a cylinder or rotational motion in a rotary vane motor or in a turbine motor. Although it is preferable to use at least two to maximum four single-acting pneumatic-motor cylinders, it is however possible to use one or two double-acting pneumatic-motor cylinders, horizontally or vertically oriented.

Still another object of the invention is to demonstrate that various combinations between a pneumatic motor and a gas-turbine power-plant are also possible at a greater or lower thermal efficiency: simple, simple-recuperated, intercooled or intercooled-recuperated gas-turbine-cycle configurations, as well as simple and intercooled combined gas-turbine-steam-turbine cycle configurations, using an optimal compression pressure ratio and the maximum possible temperature of the cycle heat addition.

Finally, still another important object of the invention is to highlight that a more effective recuperative heat exchanger (in recuperated gas-turbine configurations) means a reduced fuel input and a higher cycle thermal efficiency of the hybrid energy system. The recuperator would have to be manufactured from a quality fire-resistant material (for instance, of an alloyed austenitic steel) and should be of such a size to enable recovering of as much heat energy from the exhaust gas as possible and a short-term storage of both the compressed gas and the exhaust gas.

A closed-loop lubrication system of the pneumatic motor (PM) of such a hybrid energy system has to be used, similar as in internal-combustion engines. PM cylinders of such a hybrid energy system need not be manufactured exclusively with a circular cross-sectional shape; cylinders of quadratic, rectangular or triangular cross-sectional shapes can also be used. PM cylinders should be equipped with at least two (2) or preferably three (3) piston rings sealing the PM like in internal-combustion engines, so that there is no transfer of gases from the PM to the crankshaft. Although combustion takes place within the PM cylinder of a pneumo-compressor engine, expected and preferred piston speed in the PM cylinder is low due to isobaric nature of combustion and expansion, preferably of the order of 1-2 m/s, depending on the compressed-heated-air/gas volumetric flow and the PM dimensions (diameter). A low piston speed enables an isobaric expansion in the PM, decreases dynamic forces and moments affecting bearings, bearing bolts etc., and thus increases service life of frictional parts.

The most applicable method of regulation of the output of such a hybrid energy system with pneumatic motor in working regimes other than nominal working regime seems to be qualitative regulation, that is, regulation of the cycle load by means of the maximum heat-addition temperature.

Generally, it can be said that pneumatic motors are best suited for small-scale applications, such as distributed power generation systems. Typically, sizes of radial-piston pneumatic motors range up to ˜35 HP (˜26 kW) at speeds of ˜4,500 rpm. Axial-piston PM-s have usually even smaller power outputs. Rotary-vane pneumatic motors can operate at speeds of up to 25,000 rpm and can deliver more specific power per pound (weight) than piston pneumatic motors. Turbine pneumatic motor is the most efficient type due to absence of internal friction, which results in no need for extensive lubrication. Because of their constructional similarity with internal-combustion engines, reciprocating pneumatic motors could certainly be manufactured to larger sizes, most likely resulting in an increased capital cost, but for a very just reason according to this invention—possibility of achieving the following cycle parameters:

(a) cycle thermal efficiencies greater than 60% in simple gas-turbine cycle configurations with pneumatic motor;
(b) cycle thermal efficiencies approaching to or greater than 70% in recuperated gas-turbine cycle configurations with pneumatic motor (depending on the recuperator effectiveness);
(c) cycle thermal efficiencies approaching to 75% in intercooled-recuperated gas-turbine cycle configurations with pneumatic motor (depending on the recuperator effectiveness);
(d) cycle thermal efficiencies greater than 75% and specific cycle outputs greater than 700 kJ/kg and approaching to 1,000 kJ/kg in simple/intercooled combined gas-turbine-steam-turbine cycle configurations with pneumatic motor.

### BRIEF DESCRIPTION OF THE DRAWINGS

FIG. 1 depicts a flow diagram of the hybrid energy system using a simple gas-turbine power-plant configuration with a pneumatic motor with two (2) single-acting cylinders.

FIG. 2 depicts a version of the flow diagram of the hybrid energy system configuration depicted in FIG. 1 which uses precooling of the gas-turbine cooling air.

FIG. 3 depicts a flow diagram of the hybrid energy system using a recuperated gas-turbine power-plant configuration with a pneumatic motor with two (2) single-acting cylinders.

FIG. 4 depicts a version of the flow diagram of the hybrid energy system configuration depicted in FIG. 3 which uses precooling of the gas-turbine cooling air.

FIG. 5 depicts a flow diagram of the hybrid energy system using an intercooled gas-turbine power-plant configuration with a pneumatic motor with two (2) single-acting cylinders, without or with optional precooling of the gas-turbine cooling air.

FIG. 6 depicts a flow diagram of the hybrid energy system using an intercooled-recuperated gas-turbine power-plant configuration with a pneumatic motor with two (2) single-acting cylinders, without or with optional precooling of the gas-turbine cooling air.

FIG. 7 depicts a flow diagram of the hybrid energy system using a simple combined gas-turbine/steam-turbine power-plant configuration with a pneumatic motor with two (2) single-acting cylinders, without or with optional precooling of the gas-turbine cooling air.

FIG. 8 depicts a flow diagram of the hybrid energy system using an intercooled combined gas-turbine/steam-turbine power-plant configuration with a pneumatic motor with two (2) single-acting cylinders, without or with optional precooling of the gas-turbine cooling air.

FIGS. 9 and 10 depict flow diagrams of the hybrid-energy-system configurations depicted in FIGS. 1, 2, 3 and 4, respectively, using a simple and a recuperated gas-turbine power-plant cycle with a pneumatic motor with four (4) single-acting cylinders, without or with optional precooling of the gas-turbine cooling air.

FIGS. 11 and 12 depict flow diagrams of the hybrid-energy-system configurations depicted in FIGS. 5 and 6, respectively, using an intercooled and an intercooled-recuperated gas-turbine power-plant configuration with a pneumatic motor with four (4) single-acting cylinders, without or with optional precooling of the gas-turbine cooling air.

FIGS. 13 and 14 depict graphs of the net plant thermal efficiency vs. maximum heat-input temperature and of the net plant thermal efficiency vs. net plant specific work, respectively, comparing the two hybrid-energy-system configurations using simple gas-turbine power-plant and simple combined gas-turbine/steam-turbine power-plant, depicted in FIGS. 1 & 2 (or FIG. 9) and FIG. 7, respectively.

FIGS. 15 and 16 depict graphs of the net plant thermal efficiency vs. maximum heat-input temperature and of the net plant thermal efficiency vs. net plant specific work, respectively, comparing the two hybrid-energy-system configurations using intercooled gas-turbine power-plant and intercooled combined gas-turbine/steam-turbine power-plant, depicted in FIG. 5 (or FIG. 11) and FIG. 8, respectively.

FIGS. 17 and 18 depict graphs of the net plant thermal efficiency vs. maximum heat-input temperature and of the net plant thermal efficiency vs. net plant specific work, respectively, for the hybrid-energy-system configurations using recuperated gas-turbine power-plant, depicted in FIGS. 3 & 4 (or FIG. 10), respectively.

FIGS. 19 and 20 depict graphs of the net plant thermal efficiency vs. maximum heat-input temperature and of the net plant thermal efficiency vs. net plant specific work, respectively, for the hybrid-energy-system configuration using intercooled-recuperated gas-turbine power-plant, depicted in FIG. 6 (or FIG. 12).

FIGS. 21 and 22 depict graphs of the net plant thermal efficiency vs. maximum heat-input temperature and of the net plant thermal efficiency vs. net plant specific work, respectively, comparing the two hybrid-energy-system configurations using recuperated gas-turbine power-plant and simple combined gas-turbine/steam-turbine power-plant, depicted in FIGS. 3 & 4 (or FIG. 10) and FIG. 7, respectively.

### DETAILED DESCRIPTION OF THE INVENTION CONFIGURATIONS

In general, the direction of flow of the various working media on all flow diagrams is marked with arrows: solid line denotes the gaseous working fluid flow or the cooling-water flow (where applicable), dashed line denotes an optional/alternative gaseous working fluid flow and cooling-fluid flow, dash-dot line denotes center lines, while dash-double-dot line denotes fuel supply. All flow diagrams shown in different figures that correspond substantially to one another are arranged so that corresponding reference numbers and explanations are valid for common components depicted in such circuit diagrams. Therefore, explanations of such common components are not repeated in the description of similar figures.

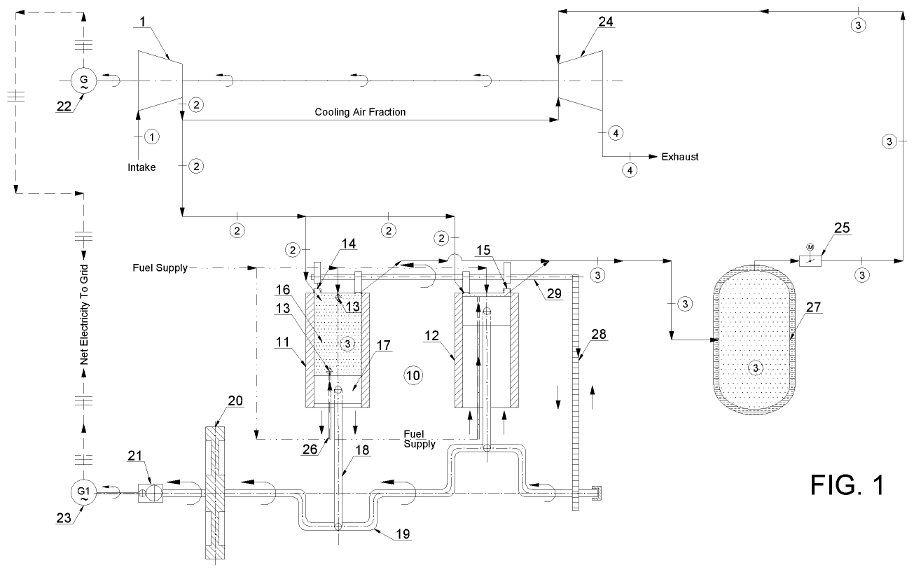

A flow diagram of the first preferred hybrid-energy-system configuration with a gas-turbine power-plant in the simple open-loop cycle and a reciprocating pneumatic motor with isobaric internal combustion with two single-acting cylinders is depicted in FIG. 1 and it consists of the following interconnected equipment/processes:
an air compressor 1 of axial, centrifugal, screw or reciprocating type, intaking atmospheric air and compressing it adiabatically from atmospheric pressure to a higher working pressure (adiabatic process “1”-“2”), equipped with an air pressure regulator (not depicted) with a screw for pressure setting, which is coupled with a gas turbine 24 and an additional load 22 by means of a common shaft;
a pneumatic motor 10 (compressed-air engine) performing a non-adiabatic isobaric expansion and isobaric combustion process “2”-“3” (for air as an ideal gas) of the compressed combustion gas, transferring the compressed-gas power into the reciprocating linear motion of pistons 17 in two horizontal or vertical single-acting cylinders 11 and 12, and then into rotational motion, thus providing a driving force of the pneumatic motor with internal combustion; although two single-acting pneumatic-motor cylinders 11 and 12 are shown with reciprocating linear motion, one double-acting cylinder may be used; whereby the said pneumatic motor 10 with reciprocating linear motion of pistons contains the following interconnected equipment/components: at least two said single-acting cylinders 11 and 12 (or at least one double-acting cylinder) of a circular, quadratic, rectangular or triangular cross-sectional shape; associated pistons 17 with reciprocating linear motion through the said cylinders 11 and 12, each piston being equipped with at least two (2) or preferably three (3) piston rings, like in internal-combustion engines, sealing the said pneumatic motor 10 so that gases cannot escape it, whereby one or two upper/inner piston rings serve primarily for compression sealing (compression rings), whereas the lower/outer ring (oil control ring) serves for controlling the supply of lubrication oil to the said pistons 17 and the said compression rings; associated openings/valves for inlet (14) of the compressed-heated-gas to the said cylinders and outlet (15) of the exhaust gas from the said cylinders, respectively; connecting rods 18 providing physical connection between the said pistons 17 and a crankshaft 19, which facilitates conversion/transformation of the reciprocating linear motion of the pistons into a rotational motion; a camshaft 29 equipped with cams/eccentricities and accurately adjusted with motion of the said crankshaft 19, facilitating adequate and timely alternate opening and closing of the said opening/closing valves 14/15, respectively, by means of its rotation; and a timing belt/timing chain 28 providing an indirect connection and an accurate transmission of motion from the said crankshaft 19 to the said camshaft 29;
openings for injection of fuel in complete with electric fuel igniters (13), comprised within the said pneumatic motor 10, for a complete isobaric combustion (isobaric process “2”-“3”) of a gaseous (typically natural gas) or a liquid fuel in the stream of compressed air, whereby the desirable locations/ways of injecting the gaseous or liquid fuel and igniting it by an electrical spark (like in a spark-ignition engine) into an operating cylinder of the said pneumatic motor 10 are three-fold: (i) at the top dead center of the operating cylinder, (like in a classic spark-ignition internal-combustion engine); (ii) at the upper side of the operating piston using a flexible fuel pipe 26 inserted thru the piston, so that the fuel ignites during the piston movement towards the bottom dead center and stops igniting when the bottom dead center has been reached; and (iii) combined injection and ignition of fuel by simultaneous use of the said methods (i) and (ii);
a closed-loop lubrication system of the said pneumatic motor 10 similar as in internal-combustion engines, whereby lubricating oil is sucked out of an oil sump/tank by an oil pump and then forced through an oil filter to the main bearings of the said pneumatic motor 10 and then it passes through feed-holes into drilled passages in the said crankshaft 19 and onto the big-end bearings of the said connecting rods 18, whereas the cylinders walls and piston-pin bearings of the said connecting rods 18 are lubricated by oil drops dispersed by the rotating crankshaft 19, the excess of the lubricating oil being scraped off by the said lower rings in the said pistons 17, whereas a small fraction of the oil is bled from the main supply passage feeding each bearing of the said camshaft 29, said valves (14 and 15) and valves' springs, while another oil bleed supplies the said timing belt/chain 28 and gears on the said camshaft (29) drive, the excess of lubricating oil being drained back to the said oil sump, where eventually collected heat is being dispersed to the surrounding air;
preferably, a flywheel 20 of the said pneumatic motor 10 for maintaining rotational speed of the said crankshaft 19 using its inertial forces (moment of inertia), thus equalizing a potentially fluctuating torque of the pneumatic motor during startup/operation/transients;
a gearbox 21 for transmission of relatively slow rotational speed of the said crankshaft 19 into a rotational speed needed for a rotor of an electric generator;
a load, typically an electric generator 23 for electricity generation, connected to the said pneumatic-motor crankshaft 19 by means of the said gearbox 21;
a well-insulated combusted-gas collecting tank 27 provided at the outlet of the said pneumatic motor 10, for combusted-gas storage and equalizing of a potentially fluctuating combusted-gas flow rate from the said pneumatic motor 10;
a motorized butterfly valve 25 for adjusting/regulating of the exhaust-gas pressure at the outlet of the said pneumatic motor 10, that is, at the inlet of a combustion-gas turbine 24, at a level close to or slightly lower than the maximum compressed-air pressure;
the said combustion gas turbine 24 for a full adiabatic expansion process “3”-“4” of the combusted gas from the said single-acting cylinders 11 and 12 of the said pneumatic motor 10, driving both the said air compressor 1 and the mentioned additional load 22 by means of a common shaft;
a cooling-air line for necessary cooling of profiles (stator, rotor) of the said gas turbine 24, by means of branching-off a small fraction of the compressed air from the outlet of the said air compressor 1 and before the inlet to the said pneumatic motor 10; and
the said additional load, typically an electrical generator 22, for additional electricity generation, connected to the said common shaft of the said combustion-turbine 24 and the said air compressor 1.

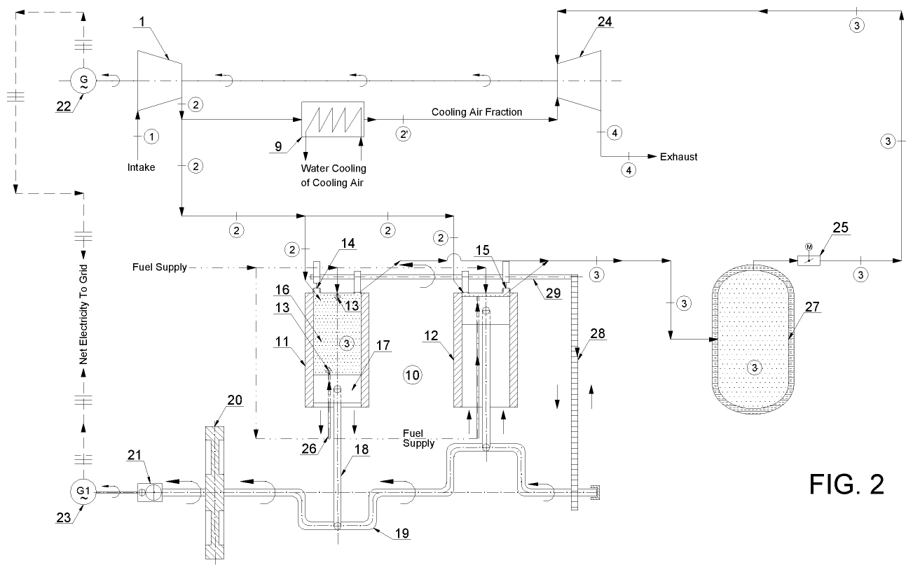

FIG. 2 depicts a flow diagram of a version of the hybrid-energy-system configuration with a gas-turbine power-plant in the simple cycle and a reciprocating pneumatic motor with two single-acting cylinders depicted in FIG. 1, additionally employing an ambient-water-precooling of cooling air of the said gas turbine 24 profiles (isobaric cooling process “2”-“2′”) be means of an additional cooling-air precooler 9, to the end of reducing of the cooling-air fraction for the same or a similar gas-turbine cooling effect.

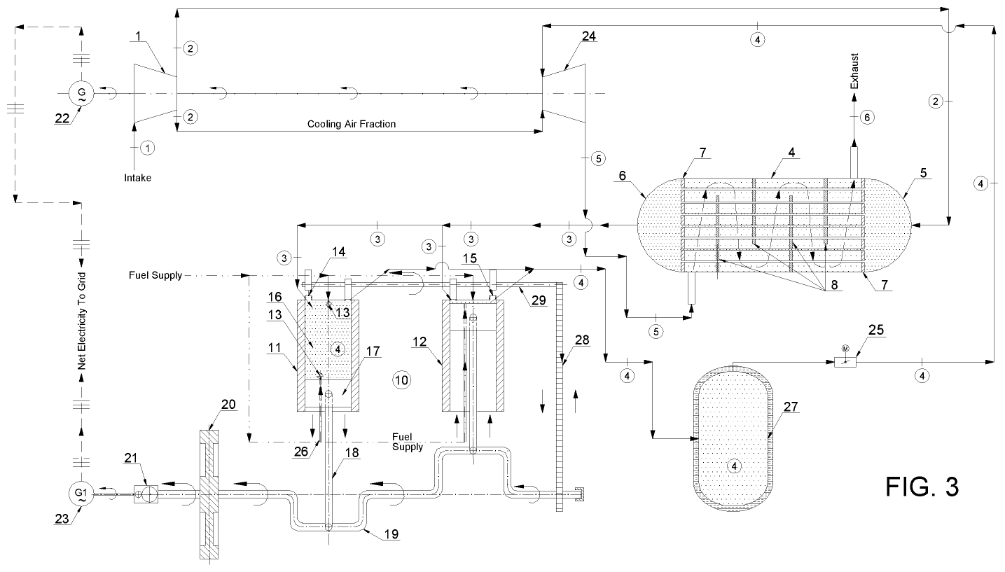

FIG. 3 depicts a flow diagram of a recuperated version of the hybrid-energy-system configuration with a gas-turbine power-plant in the simple cycle and a reciprocating pneumatic motor with two single-acting cylinders depicted in FIG. 1, employing a highly-effective recuperative heat exchanger/recuperator 4 of such a size as to enable recovering of as much waste heat energy from the exhaust gas as possible and a short-term storage of both the compressed gas and the exhaust gas, that is, a complete internal isobaric heat-exchange between the compressed air (isobaric process “2”-“3”) and the exhausted combustion gas exiting the said gas turbine 24 (isobaric process “5”-“6”), containing the following interconnected equipment/components: compressed-gas inlet and outlet compartments 5 and 6, respectively, of such a size as to enable a short-term storage of the compressed gas; two parallel tube sheets 7 for support and isolation of compressed-air tubes in the said recuperative heat exchanger 4, perforated with a pattern of holes designed to accept the tubes; several fixed/stationary baffle plates 8 mounted around the outside of the compressed-air tubes (in the recuperator shell space) for the purposes of prolonging the cross-path of exiting exhaust gas through the said recuperator 4 and thus resulting in a better gas-to-air heat transfer and a higher recuperator effectiveness.

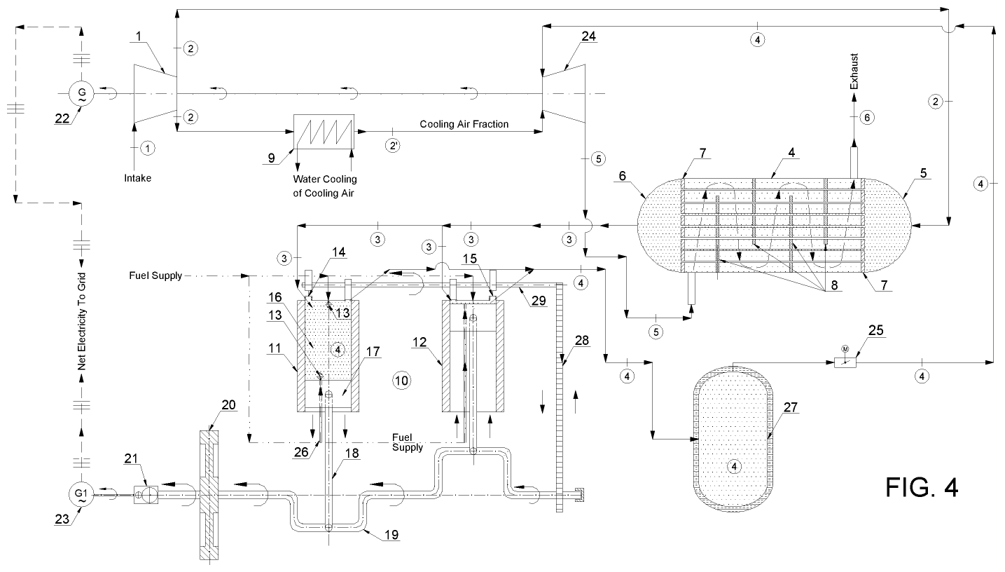

FIG. 4 depicts a flow diagram of a version of the hybrid-energy-system configuration with a gas-turbine power-plant in the recuperated cycle and a reciprocating pneumatic motor with two single-acting cylinders depicted in FIG. 3, additionally employing an ambient-water-precooling of cooling air of the said gas turbine 24 profiles (isobaric cooling process “2”-“2′”) be means of an additional cooling-air precooler 9, to the end of reducing of the cooling-air fraction for the same or a similar gas-turbine cooling effect.

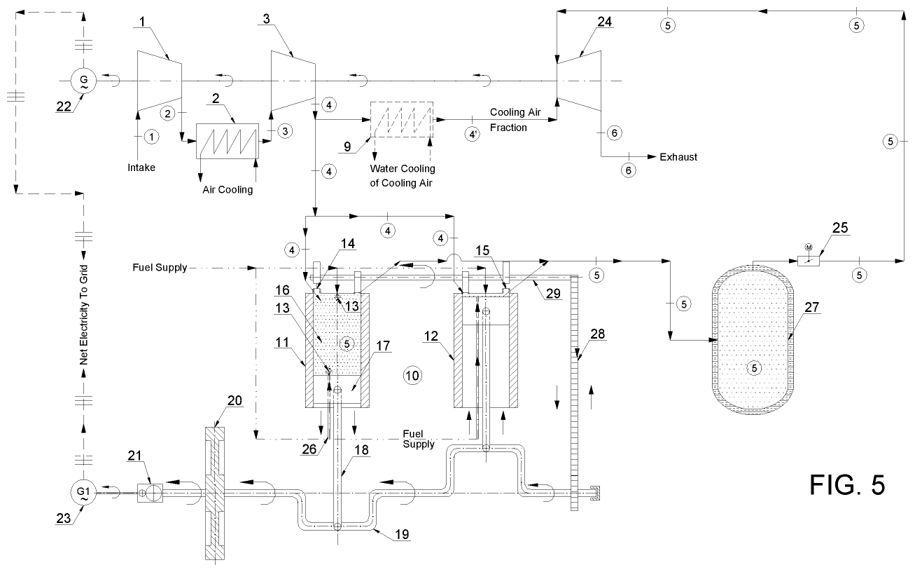

FIG. 5 depicts a flow diagram of an intercooled version of the hybrid-energy-system configuration with a gas-turbine power-plant in the simple cycle and a reciprocating pneumatic motor with two single-acting cylinders, with optional water-precooling of cooling air of the said gas turbine 24 profiles (isobaric cooling process “4”-“4′”), depicted in FIGS. 1 and 2, in a gas-turbine cycle with intercooling, additionally introducing a typical intercooling of the partially compressed air between the said compressor 1 acting as the first stage of an adiabatic compression process “1”-“2”, and a second compressor stage 3 (adiabatic compression process “3”-“4”) in an intercooler 2 (isobaric cooling process “2”-“3”), by means of ambient air or water, to the end of reducing the mechanical work required for driving of the said air compressor stages 1 and 3 and thus achieving a greater cycle specific work.

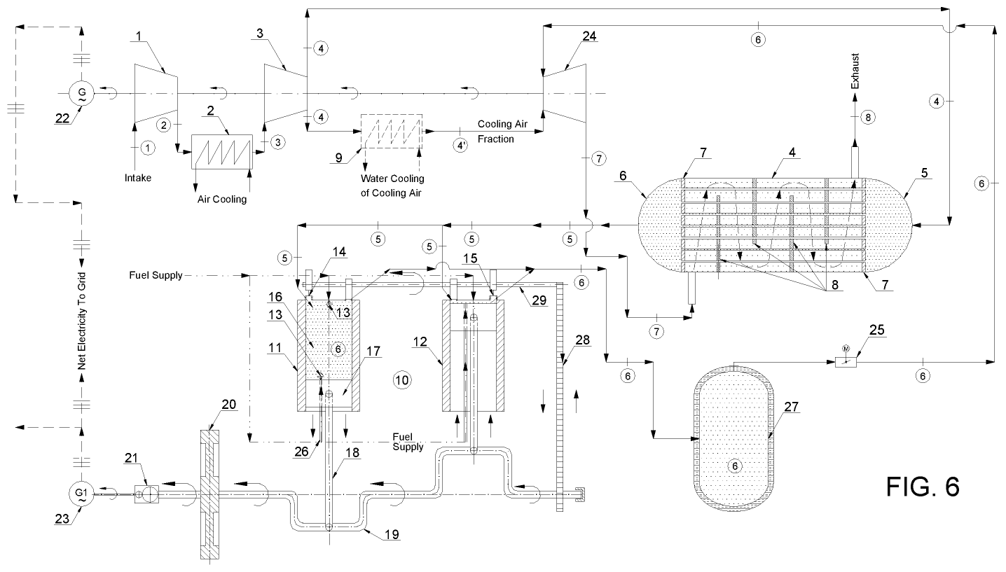

FIG. 6 depicts a flow diagram of an intercooled-recuperated version of the hybrid-energy-system configuration with a gas-turbine power-plant in the recuperated cycle and a reciprocating pneumatic motor with two single-acting cylinders, with optional water-precooling of cooling air of the said gas turbine 24 profiles (isobaric cooling process “4”-“4′”), depicted in FIGS. 3 and 4, in a gas-turbine cycle with recuperation and intercooling, additionally employing a typical intercooling of the partially compressed air between the said compressor 1 acting as the first stage of an adiabatic compression process “1”-“2”, and a second compressor stage 3 (adiabatic compression process “3”-“4”) in an intercooler 2 (isobaric cooling process “2”-“3”), by means of ambient air or water, to the end of reducing the mechanical work required for driving of the said air compressor stages 1 and 3 and thus achieving a greater cycle specific work.

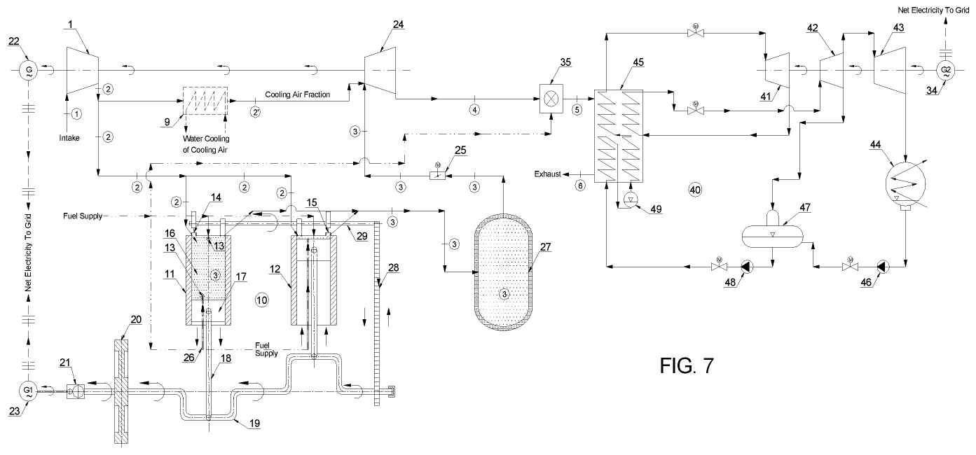

FIG. 7 depicts a flow diagram of a version of the hybrid-energy-system configuration with a gas-turbine power-plant in the simple cycle and a reciprocating pneumatic motor with two single-acting cylinders, with optional water-precooling of cooling air of the said gas turbine 24 profiles (isobaric cooling process “2”-“2′”), depicted in FIG. 1, in a combined-cycle of a gas turbine and a steam turbine, optionally using a typical supplementary firing of the exhaust combusted gas, fully expanded in the said gas turbine 24, in an additional combustion chamber 35 (isobaric heating process “4”-“5”), to the end of providing necessary temperature for production of a desired amount of steam in the bottoming steam-cycle power-plant of the combined gas-turbine-steam-turbine power-plant, whereas the said steam-turbine part of the said combined gas-turbine-steam-turbine power-plant consists of the following interconnected equipment/processes:
a heat recovery boiler 45 for raising of a desired quantity of superheated steam to be expanded in a typical steam turbine of the said bottoming steam-cycle power-plant, containing: a water heater (economizer) and evaporator, a steam drum 49 for separation of gas and liquid phases (steam and water), a steam superheater and optionally a steam reheater;
the said typical three-cylinder condensing steam turbine enabling a full expansion of the superheated steam raised in the said heat recovery boiler 45 to the lowest cycle pressure in a condenser 44; the said condensing steam turbine consisting of: a high-pressure cylinder 41 supplied by superheated steam from the said superheater of the said heat recovery boiler 45, an intermediate-pressure cylinder 42 supplied by superheated steam from the said reheater of the said heat recovery boiler 45, and a low-pressure cylinder 43;
the said condenser 44 enabling full liquefaction (condensation) of the steam fully expanded in the said steam-turbine cylinders (41, 42 and 43) to the lowest cycle pressure in the said condenser 44, being equipped with a necessary steam-ejection device for extraction of air and other non-condensable gases from the condensate;
a condensate pump 46 for pressurizing and circulation of the water condensed in the said condenser 44;
an open feedwater tank with deaerator 47, being fed with an intermediate-pressure steam extracted at the exit of the said intermediate-pressure condensing-steam-turbine cylinder 42, intended primarily for degassing of the incoming condensate/feedwater, as well as a corresponding condensation of the steam extracted from the intermediate-pressure steam-turbine cylinder by means of its mixing with the bulk of the condensate/feedwater in the said deaerator storage tank 47;
a feedwater pump 48 for pressurizing and circulation of the feedwater from the said feedwater tank 47; and
an additional electrical generator 34 for additional electricity generation, connected to the said steam-turbine cylinders (41, 42 and 43) via a common rotating shaft.

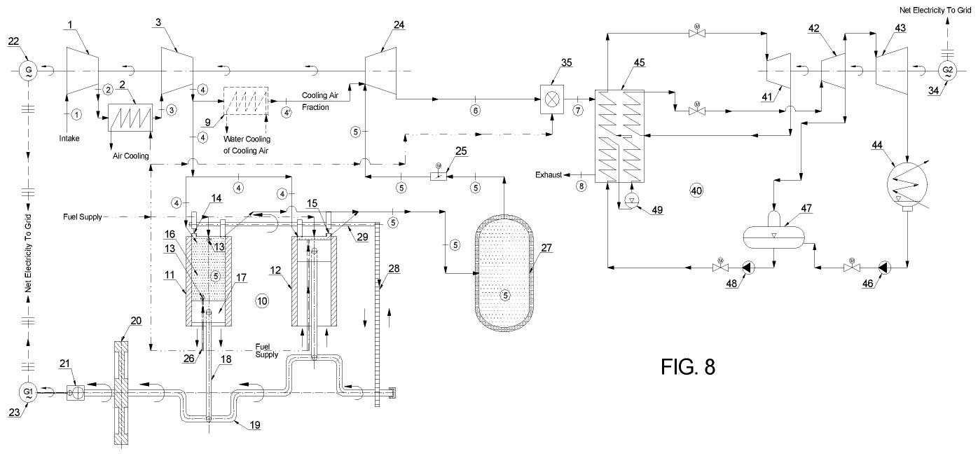

FIG. 8 depicts a flow diagram of an intercooled version of the hybrid-energy-system configuration with a gas-turbine power-plant in the simple-combined gas-turbine/steam-turbine cycle and a reciprocating pneumatic motor with two single-acting cylinders, with optional water-precooling of cooling air of the said gas turbine 24 profiles (isobaric cooling process “4”-“4′”), depicted in FIG. 7, in a gas-turbine cycle with intercooling, additionally employing a typical intercooling of the partially compressed air between the said compressor 1 acting as the first stage of an adiabatic compression process “1”-“2”, and a second compressor stage 3 (adiabatic compression process “3”-“4”) in an intercooler 2 (isobaric cooling process “2”-“3”), by means of ambient air or water, to the end of reducing the mechanical work required for driving of the said air compressor stages 1 and 3 and thus achieving a greater cycle specific work.

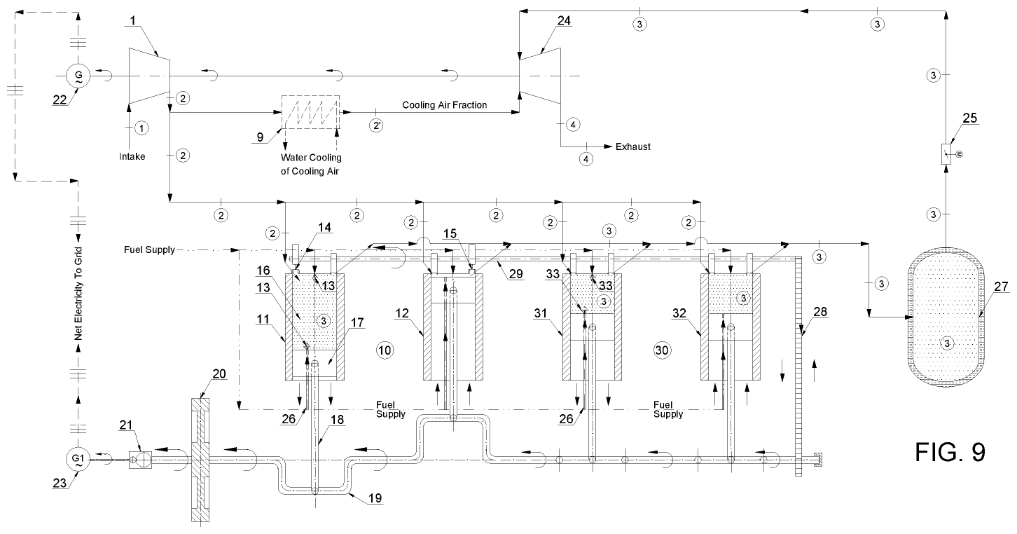

FIG. 9 depicts a flow diagram of the hybrid-energy-system configurations with a gas-turbine power-plant in the simple cycle depicted in FIGS. 1 and 2, with optional water-precooling of cooling air of the said gas turbine 24 profiles (isobaric cooling process “2”-“2′”), which uses a pneumatic motor with four single-acting cylinders, or optionally with two double-acting cylinders, to the end of equalizing of a potentially fluctuating combusted-gas flow rate and torque from the pneumatic motor and providing a more balanced and a smoother operation of the said air compressor 1.

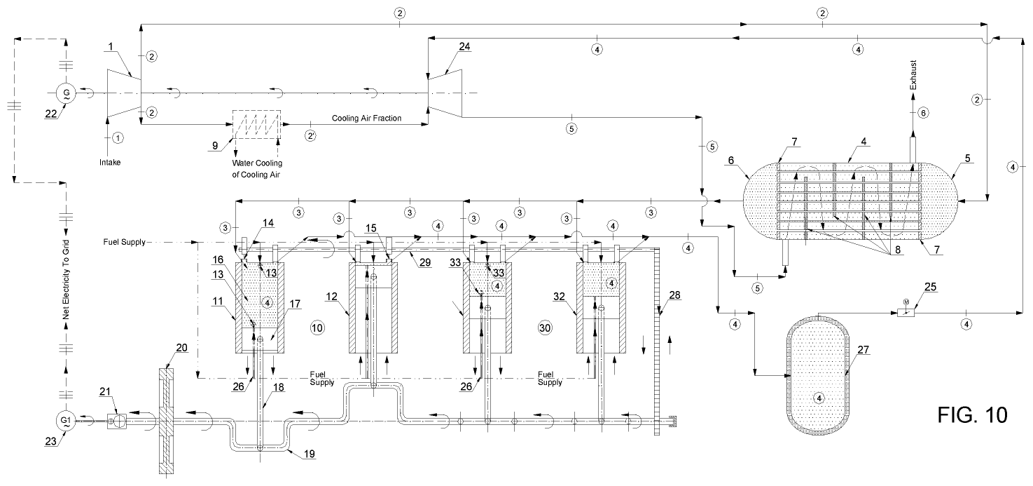

FIG. 10 depicts a flow diagram of the hybrid-energy-system configurations with a gas-turbine power-plant in the recuperated cycle depicted in FIGS. 3 and 4, with optional water-precooling of cooling air of the said gas turbine 24 profiles (isobaric cooling process “2”-“2′”), which uses a pneumatic motor with four single-acting cylinders, or optionally with two double-acting cylinders, to the end of equalizing of a potentially fluctuating combusted-gas flow rate and torque from the pneumatic motor and providing a more balanced and a smoother operation of the said air compressor 1.

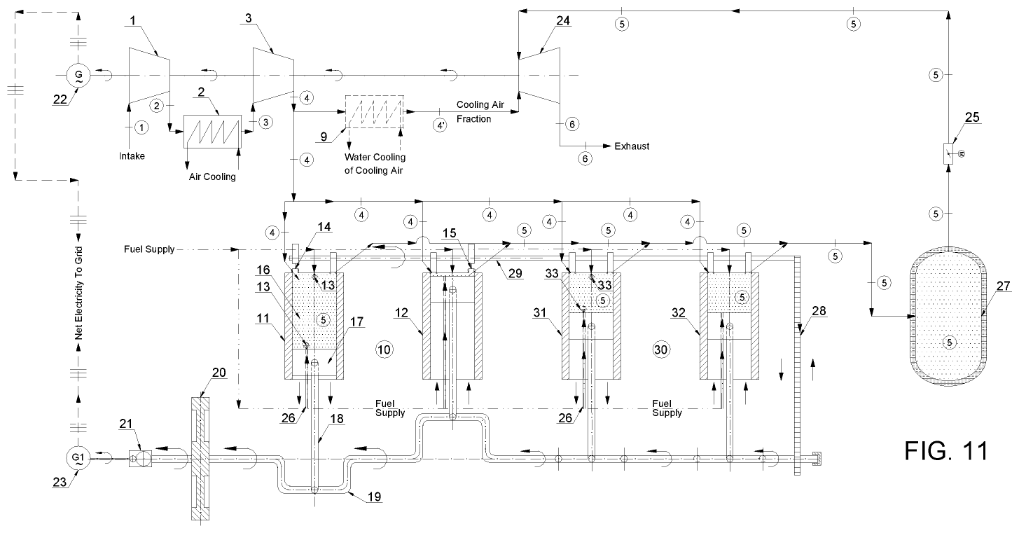

FIG. 11 depicts a flow diagram of the hybrid-energy-system configuration with a gas-turbine power-plant in the intercooled cycle depicted in FIG. 5, with optional water-precooling of cooling air of the said gas turbine 24 profiles (isobaric cooling process “4”-“4′”), which uses a pneumatic motor with four single-acting cylinders, or optionally with two double-acting cylinders, to the end of equalizing of a potentially fluctuating combusted-gas flow rate and torque from the pneumatic motor and providing a more balanced and a smoother operation of the said air compressors 1 and 3.

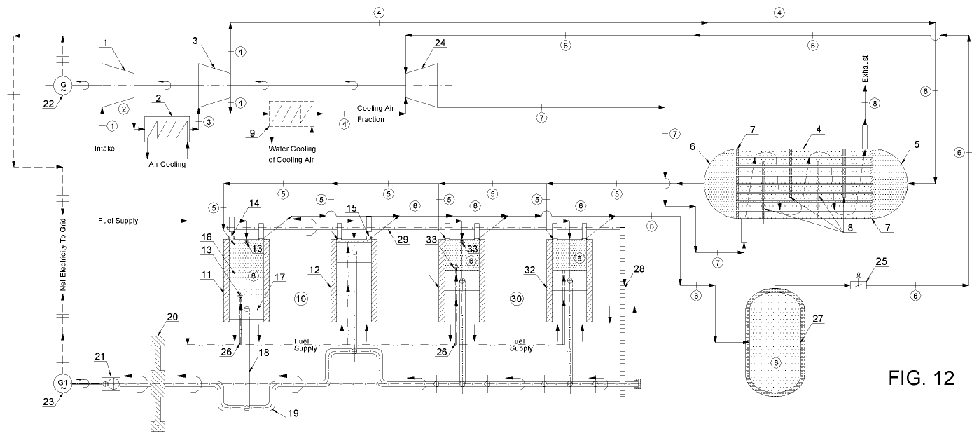

FIG. 12 depicts a flow diagram of the hybrid-energy-system configuration with a gas-turbine power-plant in the intercooled-recuperated cycle, depicted in FIG. 6, with optional water-precooling of cooling air of the said gas turbine 24 profiles (isobaric cooling process “4”-“4′”), which uses a pneumatic motor with four single-acting cylinders, or optionally with two double-acting cylinders, to the end of equalizing of a potentially fluctuating combusted-gas flow rate and torque from the pneumatic motor and providing a more balanced and a smoother operation of the said air compressors 1 and 3.

Applied Mathematical Model

A brief thermodynamic and fluid mechanic analysis of applied simple mathematical model of this concept is presented hereinafter.

General assumption No. 1 presumes equality/conservation of volumetric and mass flow rates of compressible gaseous fluid (air) in the pneumatic motor with internal combustion.

General assumption No. 2 presumes existence of isobaric (constant-pressure) flow of compressed heated compressible gas (compressed hot air) throughout the pneumatic-motor cylinder, from a smaller to a larger volume. This general assumption thus presumes that the compressed compressible fluid performs an isobaric work during the process of isobaric expansion between a smaller and a larger volume in the pneumatic-motor cylinder.

General assumption No. 3 presumes that the compressed compressible fluid flows in an isenthalpic (isothermal for ideal gases) manner during the processes of flowing in and out of the pneumatic-motor cylinder.

There are several basic thermodynamic and fluid mechanic equations applied in this mathematical model. The first and the second equation give the well-known relationships of the temperature- and pressure-ratios of the compressible-fluid compression and expansion processes, respectively, based on isentropic efficiencies of the compressor and the gas turbine:

$$\begin{matrix}\frac{{T}_{Com , out}}{{T}_{Com , i n}} = 1 + [ {( \frac{{p}_{Com , out}}{{p}_{Com , i n}} )}^{\frac{( {κ}_{C} - 1 )}{{κ}_{C}}} - 1 ] \cdot \frac{1}{{η}_{i C}} = 1 + [ CP {R}^{\frac{{R}_{a i r}}{{C}_{p , C}}} - 1 ] \cdot \frac{1}{{η}_{i C}} & [ 1 ] \\ \frac{{T}_{GT , out}}{{T}_{GT , i n}} = 1 - [ 1 - {( \frac{{p}_{GT , i n}}{{p}_{GT , out}} )}^{\frac{( 1 - {κ}_{EX} )}{{κ}_{EX}}} ] \cdot {η}_{i E X} = 1 - [ 1 - {EPR}^{\frac{( - {R}_{a i r} )}{{C}_{p , EX}}} ] \cdot {η}_{i E X} & [ 2 ]\end{matrix}$$

where: T_{Com,in} (15° C. or 288 K by default) and T_{Com,out} (in K) are air static temperatures before and after compression, respectively; p_{Com,in} (in bar or kPa) and p_{Com,out} (in bar or kPa) are air static pressures before and after compression, respectively; CPR is the compressor pressure ratio (p_{Com,out}/p_{Com,in}); Rₐᵢᵣ is the air gas constant (0.287 kJ/kg*K by default); k_{c} is an average ratio of the specific heats (Cₚ/Cᵥ) of air during compression (1.40 by default); C_{p,c} (in kJ/[kg*K]) is mean constant-pressure specific heat of air during compression, assumed to have a value of ˜1.005 kJ/(kg*K) corresponding to the value of 1.40 of an average ratio of specific heats (Cₚ/Cᵥ) of air during compression process; T_{GT,in} (in K) and T_{GT,out} (in K) are exhaust-gas static temperatures before and after expansion, respectively; p_{GT,in} (in bar or kPa) and p_{GT,out} (in bar or kPa) are exhaust-gas static pressures before and after expansion, respectively; EPR is the expansion pressure ratio (p_{GT,in}/p_{GT,out}), k_{EX} is an average ratio of the specific heats (Cₚ/Cᵥ) of exhaust gas during expansion (typically 1.33); C_{p,EX} (in kJ/[kg*K]) is mean constant-pressure specific heat for expansion and combustion processes in the gas turbine and the combustion chamber of the power-plant, assumed to have a value of ˜1.157 kJ/(kg*K) corresponding to the value of 1.33 of an average ratio of specific heats (Cₚ/Cᵥ) of air during expansion and combustion processes; η_{iC} is the compressor isentropic efficiency, assumed to have a constant value of 85%, regardless of the compressor pressure ratio and losses; and η_{iEX} is the gas-turbine isentropic efficiency, assumed to have a constant value of 90%, regardless of the expansion pressure ratio and losses.

The expansion pressure ration (EPR) is defined by the following expression:

$$EPR = \frac{{p}_{GT , i n}}{{p}_{GT , out}} = CPR \cdot \frac{{( 0.95 )}^{3} \cdot {( 0.95 )}^{2} \cdot {( 0.975 )}^{( {N}_{Com} - 1 )}}{( 1.11 )} \qquad [ 3 ]$$

where: factor (0.95)³ involves inevitable parasitic pressure losses, assumed to be 5% through the combustion chamber, 5% through the compressed-air path side of the recuperative heat exchanger (if there is any in the GT configuration) and also 5% through pneumatic-motor components (pipes, inlet opening/valve); factor (0.95)² similarly involves inevitable parasitic pressure losses, assumed to be 5% through the exhaust-gas path side of the recuperative heat exchanger (if there is any in the GT configuration) and also 5% through the pneumatic-motor components (outlet opening/valve, pipes); factor (0.975)^{(Ncom-1)} similarly involves inevitable parasitic pressure losses, assumed to be 2.5% through any intercooler (if there is any in the GT configuration) of the partially-compressed-air, whereas N_{com} is the number of air-compressor stages; and factor (1.11) takes into account additional pressure losses due to flowing of the exhaust GT gas to atmosphere at a velocity greater than zero.

The third applied equation is a thermodynamics expression for the specific work/output of the pneumatic motor, w_{PM}, which is proportional to the difference of volumes of a pneumatic-motor cylinder during the suction of the pressurized air/gas at a constant pressure, as follows:

$${w}_{P M} = p \cdot \frac{Δ V}{{m}_{a i r}} \cdot {η}_{P M} = p \cdot \frac{( {V}_{m ax} - {V}_{m i n} )}{{m}_{a i r}} \cdot {η}_{P M} = {R}_{a i r} \cdot ( {T}_{m ax} - {T}_{Com , out} [ or {T}_{r e c} ] ) \cdot {η}_{P M} [ \frac{kJ}{kg} ] \qquad [ 4 ]$$

where: mₐᵢᵣ (in kg) is total mass of the compressed heated working gas contained in a pneumatic-motor cylinder; R_{aft} is the gas constant for air (0.287 kJ/(kg*K) by default); p_{Com,out} (kPa) is a maximum static pressure through the pneumatic motor; Vₘₘ (m³) is a minimum volume of a pneumatic-motor cylinder; Vₘₐₓ (m³) is the maximum volume of a pneumatic-motor cylinder; Tₘₐₓ (K) is the maximum air/gas static temperature at the outlet of the combustion chamber (the pneumatic motor); T_{rec} (in K) is the static air temperature at the recuperative-heat exchanger-outlet (if there is any in the GT configuration), that is, at the combustor inlet; and η_{PM} is mechanical efficiency of the pneumatic motor (taking into account mechanical losses in the gearbox and the electric motor), assumed to amount to 98%.

The fourth applied equation presents an energy equation for the combustion process in the combustion chamber. Specific heat input, qᵢₙ (in kJ/kg), of the pneumo-engine can be expressed from the corresponding energy equation:

$${q}_{i n} = {C}_{p , EX} \cdot ( {T}_{m ax} - {T}_{r e c} ) = {C}_{p , EX} \{ {T}_{m ax} - ⌊ {T}_{Com , out} + {η}_{r e c} \cdot ( {T}_{GT , out} - {T}_{Com , out} ) ⌋ \} == {C}_{p , EX} [ {T}_{m ax} - {T}_{Com , out} \cdot ( 1 - {η}_{r e c} ) - {T}_{GT , out} \cdot {η}_{r e c} ] [ \frac{kJ}{kg} ] \qquad [ 5 ]$$

where: Tₘₐₓ (in K) is the maximum air/exhaust-gas static temperature at the combustor outlet; and η_{rec} (is effectiveness of the recuperative heat exchanger (if there is any in the GT configuration).

Total cycle thermal efficiency (η_{th,PM-GT}) of the hybrid energy system is given in the form of the ratio net-power-output/total-heat-input, taking into account inefficiencies in the compression and expansion processes, as follows:

$${η}_{th , PM \text{-} GT} = \frac{\begin{matrix}{w}_{PM} \cdot ( 1 - \frac{{cool}_{}}{{air}_{}} ) + \\ {C}_{p , EX} \cdot ( {T}_{GT , i n} - {T}_{GT , out} ) - {C}_{p , C} \cdot ( {T}_{Com , out} - {T}_{Com , i n} )\end{matrix}}{{q}_{i n} \cdot ( 1 - \frac{{cool}_{}}{{air}_{}} )} \qquad [ 6 ]$$

where: mₐᵢᵣ (in kg or kg/s) is total mass/mass flow rate of the compressed working gas at the compressor discharge; m_{cool} (in kg or kg/s) is a fraction of the total mass/mass flow rate of the compressed air that is branched off before the said pneumatic motor-combustor to provide necessary cooling of profiles (stator, rotor) of the gas turbine; and η_{th,PM-GT} is the total cycle thermal efficiency of the hybrid energy system with pneumatic motor.

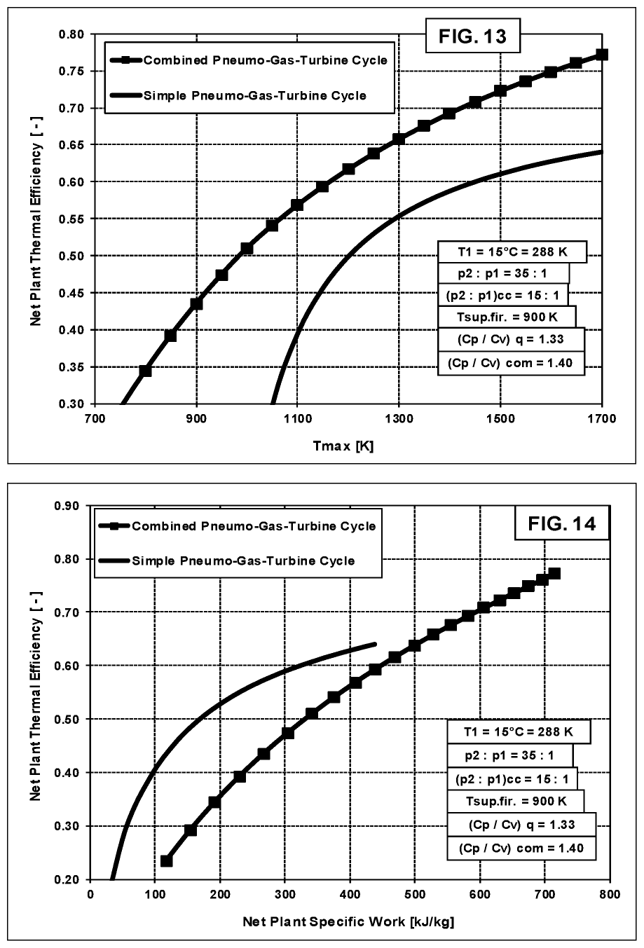

Using the described mathematical model, the following graphs (FIGS. 13 through 22) were obtained, shown in the drawings section of this patent application. The first graph in FIG. 13 compares changes of the net plant thermal efficiency vs. maximum heat-input temperature for the two configurations of hybrid energy system gas turbine—pneumatic motor using simple gas-turbine power-plant and simple combined gas-turbine/steam-turbine power-plant, depicted in FIGS. 1 and 2 (or FIG. 9) and FIG. 7, respectively. From the graph it may be noticed that the cycle thermal efficiency logically increases with the maximum heat-input temperature, reaching the following peak values at the maximum considered heat-input temperature of 1,700 K (1,427° C.): 0.641 (64.1%) at a constant arbitrarily chosen optimum compressor pressure ratio (CPR) of 35:1 for the configuration depicted at FIGS. 1 and 2 (or FIG. 9), and 0.772 (77.2%) (!) at a constant arbitrarily chosen optimum compressor pressure ratio (CPR) of 15:1 and at an arbitrarily chosen supplementary-firing temperature of 900 K for the configuration depicted at FIG. 7.

The second graph in FIG. 14 compares changes of the net plant thermal efficiency vs. net plant specific work/output for the two configurations of hybrid energy system gas turbine—pneumatic motor using simple gas-turbine power-plant and simple combined gas-turbine/steam-turbine power-plant, depicted in FIGS. 1 and 2 (or FIG. 9) and FIG. 7, respectively. From the graph it may be noticed that the net cycle specific work also increases with the maximum heat-input temperature, reaching the following peak values at the maximum considered heat-input temperature of 1,700 K (1,427° C.): 438.6 kJ/kg at a constant arbitrarily chosen optimum compressor pressure ratio (CPR) of 35:1 for the configuration depicted at FIGS. 1 and 2 (or FIG. 9), and 715.6 kJ/kg at a constant arbitrarily chosen optimum compressor pressure ratio (CPR) of 15:1 and at an arbitrarily chosen supplementary-firing temperature of 900 K (627° C.) for the configuration depicted at FIG. 7.

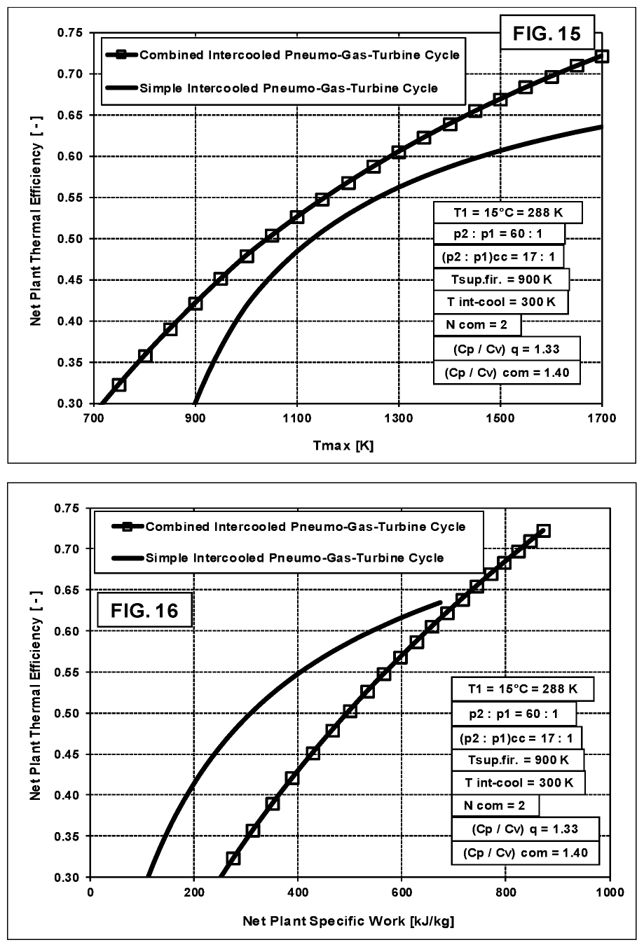

The third graph in FIG. 15 compares changes of the net plant thermal efficiency vs. maximum heat-input temperature for the two configurations of hybrid energy system gas turbine—pneumatic motor using intercooled gas-turbine power-plant and intercooled combined gas-turbine/steam-turbine power-plant, depicted in FIG. 5 (or FIG. 11) and FIG. 8, respectively. From the graph it may be noticed that the cycle thermal efficiency logically increases with the maximum heat-input temperature, reachin, the following peak values at the maximum considered heat-input temperature of 1,700 K (1,427° C.): 0.635 (63.5%) at a constant arbitrarily chosen optimum compressor pressure ratio (CPR) of 60:1 for the configuration depicted at FIG. 5 (or FIG. 11), and 0.722 (72.2%) at a constant arbitrarily chosen optimum compressor pressure ratio (CPR) of 17:1 and at an arbitrarily chosen supplementary-firing temperature of 900 K (627° C.) for the configuration depicted at FIG. 8.

The fourth graph in FIG. 16 compares changes of the net plant thermal efficiency vs. net plant specific work/output for the two configurations of hybrid energy system gas turbine—pneumatic motor using intercooled gas-turbine power-plant and intercooled combined gas-turbine/steam-turbine power-plant, depicted in FIG. 5 (or FIG. 11) and FIG. 8, respectively. From the graph it may be noticed that the net cycle specific work also increases with the maximum heat-input temperature, reaching the following peak values at the maximum considered heat-input temperature of 1,700 K (1,427° C.): 674.2 kJ/kg at a constant arbitrarily chosen optimum compressor pressure ratio (CPR) of 60:1 for the configuration depicted at FIG. 5 (or FIG. 11), and 871.3 kJ/kg at a constant arbitrarily chosen optimum compressor pressure ratio (CPR) of 17:1 and at an arbitrarily chosen supplementary-firing temperature of 900 K (627° C.) for the configuration depicted at FIG. 8.

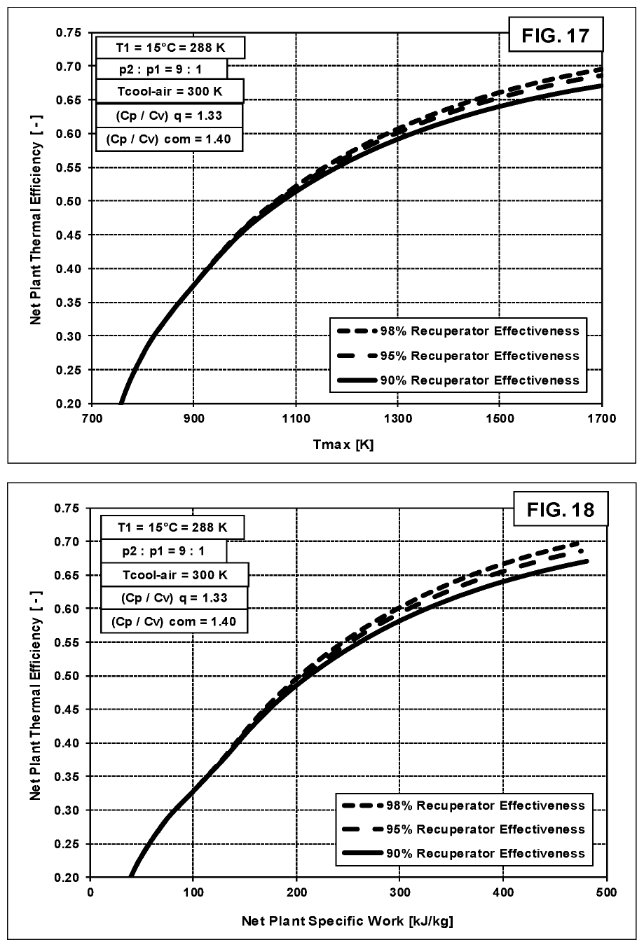

The fifth graph and the sixth graph in FIGS. 17 and 18 depict changes of the net plant thermal efficiency vs. maximum heat-input temperature and the net plant thermal efficiency vs. net plant specific work/output, respectively, for the configuration of hybrid energy system gas turbine—pneumatic motor using recuperated gas-turbine power-plant with water-precooling of the gas-turbine cooling air, depicted in FIG. 4 (or FIG. 10). From the graph it may be noticed that both the cycle thermal efficiency and the net cycle specific work logically increase with the maximum heat-input temperature and with the recuperator effectiveness, reaching the following peak values at the maximum considered heat-input temperature of 1,700 K (1,427° C.), at a constant arbitrarily chosen optimum compressor pressure ratio (CPR) of 9:1 and at three different arbitrarily assumed values of the recuperator effectiveness (90%, 95% and 98%): 0.67 (67%) and 481.5 kJ/kg, 0.686 (68.6%) and 475.4 kJ/kg, and 0.696 (69.6%) and 471.7 kJ/kg, respectively.

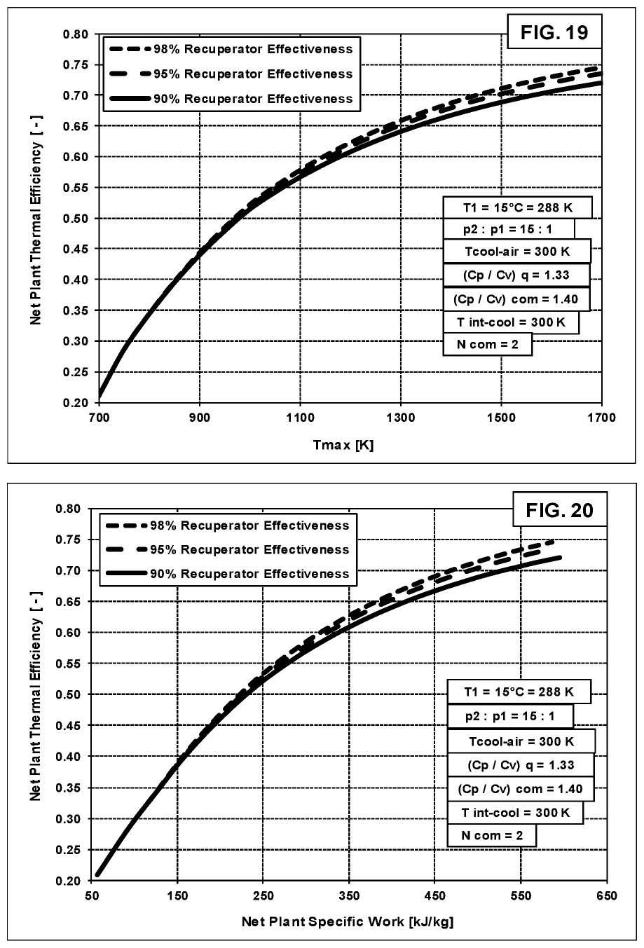

Similarly, the seventh graph and the eighth graph in FIGS. 19 and 20 depict changes of the net plant thermal efficiency vs. maximum heat-input temperature and the net plant thermal efficiency vs. net plant specific work/output, respectively, for the configuration of hybrid energy system gas turbine—pneumatic motor using intercooled-recuperated gas-turbine power-plant with water-precooling of the gas-turbine cooling air, depicted in FIG. 6 (or FIG. 12). From the graph it may be noticed that both the cycle thermal efficiency and the net cycle specific work logically increase with the maximum heat-input temperature and with the recuperator effectiveness, reaching the following peak values at the maximum considered heat-input temperature of 1,700 K (1,427° C.), at a constant arbitrarily chosen optimum compressor pressure ratio (CPR) of 15:1 and at three different arbitrarily assumed values of the recuperator effectiveness (90%, 95% and 98%): 0.72 (72%) and 595.9 kJ/kg, 0.735 (73.5%) and 589.6 kJ/kg, and 0.745 (74.5%) and 585.8 kJ/kg, respectively.

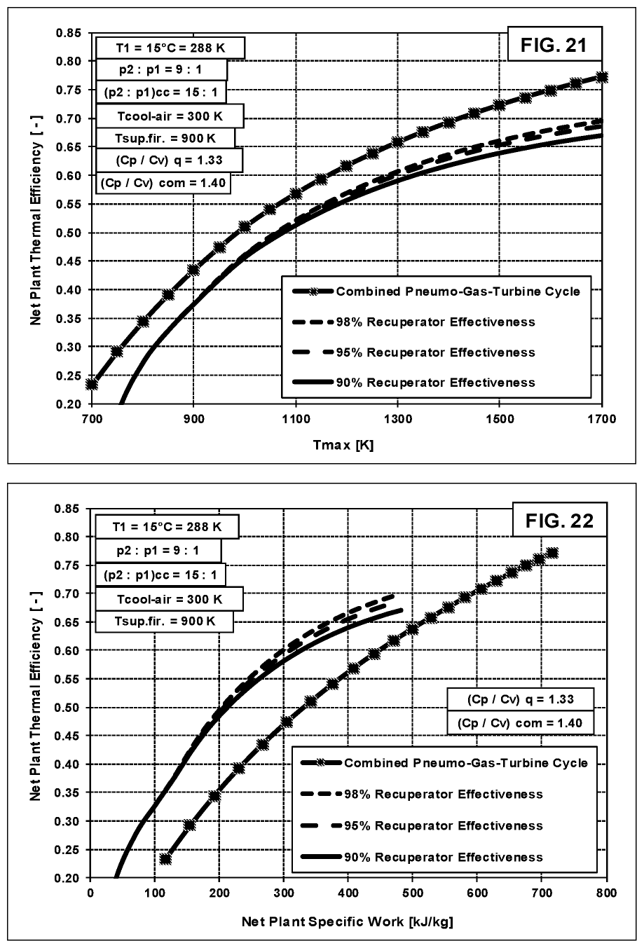

Finally, the ninth graph and the tenth graph in FIGS. 21 and 22 compare changes of the net plant thermal efficiency vs. maximum heat-input temperature and the net plant thermal efficiency vs. net plant specific work/output, respectively, for the configurations of hybrid energy system gas turbine—pneumatic motor using recuperated gas-turbine power-plant with water-precooling of the gas-turbine cooling air and simple combined gas-turbine/steam-turbine power-plant, depicted in FIG. 4 (or FIG. 10) and FIG. 7, respectively. From the graph it may be noticed that both the cycle thermal efficiency and the net cycle specific work logically increase with the maximum heat-input temperature and the recuperator effectiveness, reaching the following peak values at the maximum considered heat-input temperature of 1,700 K (1,427° C.): 0.696 (69.6%) and 471.7 kJ/kg, respectively, at a constant arbitrarily chosen optimum compressor pressure ratio (CPR) of 9:1 and at an arbitrarily assumed value of the recuperator effectiveness of 98% for the configuration depicted at FIG. 4 (or FIG. 10), and 0.772 (77.2%) and 715.6 kJ/kg, respectively, at a constant arbitrarily chosen optimum compressor pressure ratio (CPR) of 15:1 and at an arbitrarily chosen supplementary-firing temperature of 900 K (627° C.) for the configuration depicted at FIG. 7.

All numbers expressing process or cycle parameters, cycle thermal efficiencies, specific cycle outputs, and so forth, used in this specification and claims are to be understood as being modified in all instances by the term “about” or “approximately”. The matter set forth in the foregoing description and accompanying drawings is offered by way of illustration only and not as a limitation. Since further modifications, applications or adaptations of the invention may become apparent to those skilled in the art, aim of the appended patent claims is to cover all such changes and modifications as fall within the true spirit and scope of the invention.

The invention claimed is:

1. A hybrid energy system with a gas-turbine power-plant in a simple-open cycle and the reciprocating pneumatic motor with internal combustion at constant pressure, consisting of the following interconnected equipment:
a) an air compressor (1), sucking atmospheric air and compressing it adiabatically from the atmospheric pressure to a higher pressure, equipped with an air pressure regulator with a screw for pressure setting, connected to a gas turbine (24) and to an additional load (22) by means of a common shaft;
b) a pneumatic motor (10) (compressed-air engine) performing the process of an isobaric combustion and the process of a non-adiabatic isobaric expansion of the compressed combusted gas, transferring the compressed-gas power into the reciprocating linear (axial or radial) motion of pistons in two horizontal or vertical single-acting cylinders (11 and 12) and then into rotational motion, thus providing the driving force of the pneumatic motor; whereby, instead of the two said single-acting pneumatic-motor cylinders with reciprocating linear motion, one double-acting cylinder may be used; whereby the said pneumatic motor (10) with reciprocating linear motion contains the following interconnected components: at least two said single-acting cylinders (11 and 12) (or at least one double-acting cylinder) of a circular, quadratic, rectangular or triangular cross-sectional shape; associated pistons (17) with reciprocating linear motion through the said cylinders, each piston being equipped with at least two (2) or preferably three (3) piston rings, like in internal-combustion engines, sealing the said pneumatic motor (10), so that gases cannot escape it, whereby one or two upper/inner piston rings serve primarily for compression sealing (compression rings), whereas the lower/outer ring (oil control ring) serves for controlling the supply of lubrication oil to the said pistons and the said compression rings; associated openings/valves for inlet (14) of the compressed-heated-gas to the said cylinders and outlet (15) of the exhaust gas from the said cylinders, respectively; connecting rods (18) providing physical connection between the said pistons (17) and a crankshaft (19), which facilitates conversion/transformation of the reciprocating linear motion of the pistons into a rotational motion; a camshaft (29) equipped with cams/eccentricities and accurately adjusted with motion of the said crankshaft, facilitating adequate and timely alternate opening/closing of the said opening/closing valves (14 and 15), respectively, by means of its rotation; and a timing belt/timing chain (28) providing an indirect connection and an accurate transmission of motion from the said crankshaft (19) to the said camshaft (29);
c) openings (13) for injection of fuel along with electric fuel igniters, comprised within the said pneumatic motor (10), for a complete isobaric combustion of a gaseous (typically natural gas) or a liquid fuel in the stream of compressed air, whereby the desirable locations/ways of injecting the gaseous or liquid fuel and igniting it by an electrical spark (like in a spark-ignition engine) into an operating cylinder of the said pneumatic motor are three-fold: (i) at the top dead center of the operating cylinder, (like in a classic spark-ignition internal-combustion engine); (ii) at the upper side of the operating piston using a flexible fuel pipe (26) inserted thru the piston, so that the fuel ignites during the piston movement towards the bottom dead center and stops igniting when the bottom dead center has been reached; and (iii) combined injection and ignition of fuel by simultaneous use of the said methods (i) and (ii);
d) a closed-loop lubrication system of the said pneumatic motor (10), similar as in internal-combustion engines, whereby lubricating oil is sucked out of an oil sump/tank by an oil pump and then forced through an oil filter to the main bearings of the said pneumatic motor (10) and then it passes through feed-holes into drilled passages in the said crankshaft (19) and onto the big-end bearings of the said connecting rods (18), whereas the cylinders walls and piston-pin bearings of the said connecting rods (18) are lubricated by oil drops dispersed by the said rotating crankshaft (19), the excess of the lubricating oil being scraped off by the said lower rings in the said pistons (17), whereas a small fraction of the oil is bled from the main supply passage feeding each bearing of the said camshaft (29), said valves (14 and 15) and valves' springs, while another oil bleed supplies the said timing belt/chain (28) and gears on the said camshaft drive, the excess of lubricating oil being drained back to the said oil sump, where eventually collected heat is being dispersed to the surrounding air;
e) preferably, a flywheel (20) of the said pneumatic motor (10) for maintaining the rotational speed of the said crankshaft (19) using its inertial forces (moment of inertia), thus equalizing a potentially fluctuating torque of the pneumatic motor (10) during startup/operation/transients;
f) a gearbox (21) for transmission of relatively slow rotational speed of the said crankshaft (19) into a rotational speed needed for a rotor of an electric generator;
g) a load (23), typically an electric generator, for electricity generation, connected to the said pneumatic-motor crankshaft (19) by means of the said gearbox (21);
h) a well-insulated combusted-gas collecting tank (27) provided at the outlet of the said pneumatic motor (10), for combusted-gas storage and equalizing of a potentially fluctuating combusted-gas flow rate from the said pneumatic motor (10);
i) a motorized butterfly valve (25) for adjusting/regulating of the exhaust-gas pressure at the outlet of the said pneumatic motor (10), that is, at the inlet of the said gas turbine (24), at a level close to or slightly lower than the maximum compressed-air pressure;
j) the said combustion gas turbine (24) for a full adiabatic expansion process of the combusted gas flowing from the said single-acting cylinders (11 and 12) of the said pneumatic motor (10), driving both the said air compressor (1) and the said additional load (22) by means of a common shaft;
k) a cooling-air line for necessary cooling of profiles (stator, rotor) of the said gas turbine (24), by means of branching-off a small fraction of the compressed air from the outlet of the said air compressor (1) and before the inlet to the said pneumatic motor (10); whereby the cooling gas-turbine air may optionally be precooled by means of ambient air or water in an additionally employed cooling-air precooler (9); and
l) the said additional load (22), typically an electrical generator, for additional electricity generation, connected to the said common shaft of the said gas turbine (24) and the said air compressor (1).

2. A hybrid energy system according to claim 1, wherein a compressor intercooler (2) is additionally used to perform an intercooling of the partially adiabatically compressed air between the said air compressor (1), acting as the first stage of the adiabatic air-compression process, and an additional second compressor stage (3), by means of ambient air or water.

3. A hybrid energy system according to claim 1, wherein a recuperative heat exchanger (recuperator) (4) is additionally fitted between the exit of the said gas turbine (24) and the discharge side of the said compressor (1), of such a size as to enable recovering of as much waste heat energy from the exhaust gas as possible and a short-term storage of both the compressed gas and the exhaust gas, that is, a complete internal isobaric heat-exchange between the compressed air and the low-pressure exhausted combustion gas exiting the said gas turbine (24), containing the following interconnected equipment/components: compressed-gas inlet (5) and outlet (6) compartments, respectively, of such a size as to enable a short-term storage of the compressed gas; two parallel tube sheets (7) for support and isolation of compressed-air tubes in the said recuperative heat exchanger (4), perforated with a pattern of holes designed to accept the tubes; several fixed/stationary baffle plates (8) mounted around the outside of the compressed-air tubes (in the recuperator shell space) for the purposes of prolonging the cross-path of exiting exhaust gas through the said recuperator (4).

4. A hybrid energy system according to claim 3, wherein a compressor intercooler (2) is additionally used to perform an intercooling of the partially adiabatically compressed air between the said air compressor (1), acting as the first stage of the adiabatic air-compression process, and an additional second compressor stage (3), by means of ambient air or water.

5. A hybrid energy system according to claim 1, wherein the hybrid system additionally employs a bottoming steam-turbine part in a gas-turbine and steam-turbine combined-cycle power plant, whereas the said steam-turbine part consists of the following interconnected equipment:
a) an additional combustion chamber (35), which provides a typical supplementary firing of the exhaust gas-turbine gas, fully expanded in the said gas turbine (24), as needed, to the end of providing a necessary temperature for production of a desired amount of superheated steam in the said bottoming steam-turbine part of the combined-cycle gas-turbine-steam-turbine power-plant;
b) a heat recovery boiler (45) for raising of a desired quantity of superheated steam to be expanded in a typical steam turbine of the said bottoming steam-turbine part of the combined-cycle power-plant, containing the following main components: a water heater (economizer) and evaporator, a steam drum (49) for separation of gas and liquid phases (steam and water), a steam superheater and, optionally, a steam reheater;
c) the said typical three-cylinder condensing steam turbine enabling a full expansion of the superheated steam raised in the said heat recovery boiler (45) to the lowest cycle pressure in a condenser (44); whereby the said condensing steam turbine consists of: a high-pressure cylinder (41) supplied by superheated steam from the superheater of the said heat recovery boiler (45), an intermediate-pressure cylinder (42) supplied by superheated steam from the reheater of the said heat recovery boiler (45), and a low-pressure cylinder (43);
d) the said condenser (44) enabling full liquefaction (condensation) of the steam fully expanded in the said steam-turbine cylinders (41, 42 and 43) to the lowest cycle pressure in the said condenser (44), being equipped with a necessary steam-ejection device for extraction of air and other non-condensable gases from the condensate;
e) a condensate pump (46) for pressurizing and circulation of the water condensed in the said condenser;
f) an open feedwater tank (47) with deaerator, being fed with an intermediate-pressure steam extracted at the exit of the said intermediate-pressure cylinder (42) of the said condensing steam turbine, intended primarily for degassing of the incoming condensate/feedwater, but also for corresponding condensation of the steam extracted from the intermediate-pressure steam turbine, by mixing with the bulk of the condensate/feedwater in the said feedwater storage tank (47);
g) a feedwater pump (48) for pressurizing and circulation of the feedwater from the said feedwater tank (47); and
h) an additional electrical generator (34) for additional electricity generation, connected to the said steam-turbine cylinders (41, 42 and 43) via a common rotating shaft.

6. A hybrid energy system according to claim 5, wherein a compressor intercooler (2) is additionally used to perform an intercooling of the partially adiabatically compressed air between the said air compressor (1), acting as the first stage of the adiabatic air-compression process, and an additional second compressor stage (3), by means of ambient air or water.

7. A hybrid energy system according to claims 1, 3 and 5, wherein the said pneumatic motor (10) uses four single-acting cylinders, or optionally two double-acting cylinders, to the end of equalizing of a potentially fluctuating exhaust-gas flow rate and torque from the said pneumatic motor (10) and providing a balanced and smooth operation of the said air compressor (1).

8. A hybrid energy system according to claims 2, 4 and 6, wherein the said pneumatic motor (10) uses four single-acting cylinders, or optionally two double-acting cylinders, to the end of equalizing of a potentially fluctuating exhaust-gas flow rate and torque from the said pneumatic motor (10) and providing a balanced and smooth operation of the said first and second air-compressor stages (1 and 3).
